(19) United States
(12) Patent Application Publication
(10) Pub. No.: US 2009/0245885 A1
(43) Pub. Date: Oct. 1, 2009

(54) DEVELOPING DEVICE AND IMAGE FORMING APPARATUS

(75) Inventors: Katsumi Okamoto, Azumino-shi (JP); Koji Migita, Matsumoto-shi (JP); Makoto Sato, Matsumoto-shi (JP); Takeshi Aoki, Matsumoto-shi (JP); Masashi Nakatsu, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/407,070

(22) Filed: Mar. 19, 2009

(30) Foreign Application Priority Data
Mar. 31, 2008 (JP) 2008-089101

(51) Int. Cl. G03G 15/08

(52) U.S. Cl. 399/263

(57) ABSTRACT

A developing device includes a developing agent carrying body that carries toner, a toner supply member that supplies toner to the developing agent carrying body, a regulating member that regulates an amount of toner present on the developing agent carrying body, a developing chamber having the developing agent carrying body, the toner supply member and the regulating member, and a replaceable toner cartridge that supplies toner to the developing chamber and collects the toner from the developing chamber. When the toner cartridge is replaced with a toner cartridge storing new toner, the new toner is supplied to the developing chamber from the toner cartridge. The new toner and the toner remaining in the developing chamber are agitated to form agitated toner, and the agitated toner is collected in the toner cartridge from the developing chamber.

### BACKGROUND

1. Technical Field

The present invention relates to a developing device and an image forming apparatus each capable of developing an electrostatic latent image on a latent image carrying body by using a developing agent.

2. Related Art

An electrophotographic recording type image forming apparatus is known that forms an electrostatic latent image on a surface of a latent image carrying body in accordance with image data by exposing the latent image carrying body. The image forming apparatus forms an image such that the latent image is developed with toner by a developing device and a toner image formed on the surface of the latent image carrying body is transferred to a recording medium such as a recording paper sheet.

This type of image forming apparatus in recent years, has been generally designed so that a toner cartridge for storing toner is configured to be united with or separated from a developing device and is detachably attached to the image forming apparatus. When the stored toner is completely consumed by repeatedly developing electrostatic latent images on the surface of the latent image carrying body, toner for developing the electrostatic latent images on the surface of the latent image carrying body is supplied by replacing the toner cartridge with a new one.

In the above type of developing device, toner in a developing chamber is agitated by means of an agitating member, a toner supply roller and regulating blade for a long time, resulting in degradation in charging performance. When new toner and deteriorated toner left in the developing chamber are agitated so as to be mixed by the replacement of the toner cartridge to be used, the new toner having high charging performance may be selectively charged and charging of the deteriorated toner may become insufficient and a charging amount of the entirety of the agitated, mixed toner may become insufficient, resulting in occurrence of leakage during regulation of passing through of the toner or adhesion (fogging) of the toner to a non-imaging part.

To prevent the above problem, JP-A-2000-181216 as an example of the related art discloses a technique for treating toner left in the developing chamber such that a driving time period of the developing device is counted, and enforced writing is carried out in a non-imaging part in accordance with the driving time period, thereby consuming the toner with the degraded charging performance.

However, with the technique heretofore employed, toners having different deteriorated conditions (charging properties) are mixed in the developing chamber. The toners having different charging amounts are mixed, resulting in occurrence of leakage during regulation or fogging of the toner.

### SUMMARY

An advantage of some aspects of the invention is that it provides a developing device and an image forming apparatus each capable of making a charging amount of toner roughly uniform.

A developing device according to a first aspect of the invention includes a developing agent carrying body that carries toner, a toner supply member that supplies toner to the developing agent carrying body, a regulating member that regulates an amount of toner on the developing agent carrying body, a developing chamber having the developing agent carrying body, the toner supply member and the regulating member, and a replaceable toner cartridge that supplies toner to the developing chamber and collects the toner from the developing chamber. When the toner cartridge is replaced with a toner cartridge storing new toner, the new toner is supplied to the developing chamber from the toner cartridge. The new toner and the toner remaining in the developing chamber are agitated to form agitated toner, and the agitated toner is collected in the toner cartridge from the developing chamber. With the above configuration, it is possible to make a charge amount of the toner in the developing chamber roughly uniform when printing is first performed after replacement of the toner cartridge.

Since all the new toner in the toner cartridge is supplied to the developing chamber, it is possible to make the charge amount of the toner more uniform.

Since all the agitated toner in the developing chamber is collected in the toner cartridge, it is possible to make the charge amount of the toner more uniform.

In addition, the developing device may include a seal member that seals a portion between the developing chamber and the developing agent carrying body. Since the developing agent carrying body is not rotated while the agitating is being carried out in the developing chamber, it is possible to reduce an amount of toner leaking toward a latent image carrying body.

Since the toner supply member is rotatable forward and backward about an axis, it is possible to select one of the rotational directions corresponding to a condition.

The toner cartridge may include a cartridge agitating member. The cartridge agitating member further agitates the agitated toner in the toner cartridge after the agitated toner is collected in the toner cartridge from the developing chamber. Accordingly, it is possible to make the charge amount of the toner more uniform.

The developing device may include a first conveyance path that connects a lower part of the toner cartridge to an upper part of the developing chamber and a second conveyance path that connects a lower part of the developing chamber to an upper part of the toner cartridge. Accordingly, it is possible to smoothly perform conveying of the toner.

In addition, an image forming apparatus according to a second aspect of the invention includes at least a latent image carrying body on which an electrostatic latent image is formed, a developing device that forms a toner image on the latent image carrying body by developing the electrostatic latent image by using a developing agent, a transfer device that transfers the toner image on the latent image carrying body to a transfer medium, and a fixing device that fixes the toner image to the transfer medium. The image forming apparatus further includes the developing device mounted thereon. With the above configuration, the image forming apparatus can form an image with good quality by a roughly uniform charge amount.

### BRIEF DESCRIPTION OF THE DRAWINGS

The invention will be described with reference to the accompanying drawings, wherein like numbers reference like elements.

FIG. 1 is a schematic view illustrating an image forming apparatus according to an embodiment of the invention.

FIG. 2 is a cross-sectional view showing a periphery of a photosensitive drum and a main structural components of a developing device.

FIG. 3 is a schematic view illustrating a developing device according to the embodiment of the invention.

FIGS. 4A and 4B are schematic views illustrating a first example of the developing device according to the embodiment of the invention.

FIGS. 5A and 5B are schematic views illustrating a second example of the developing device according to the embodiment of the invention.

FIG. 6 is a graph showing a fogging amount with respect to a ratio of new toner to remaining toner.

FIG. 7 is a flowchart showing a flow of a refresh mode in the embodiment of the invention.

### DESCRIPTION OF EXEMPLARY EMBODIMENTS

The preferred embodiment according to the invention will be described with reference to the accompanying drawings.

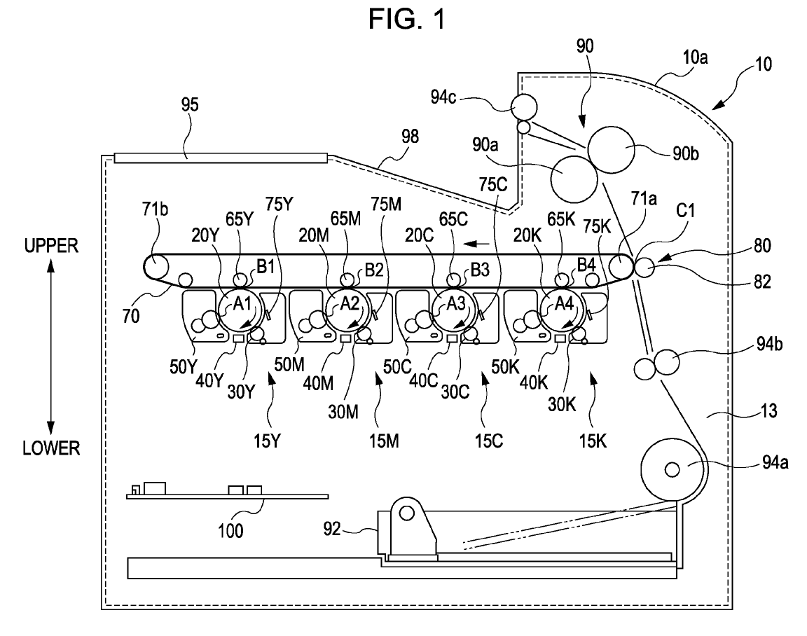

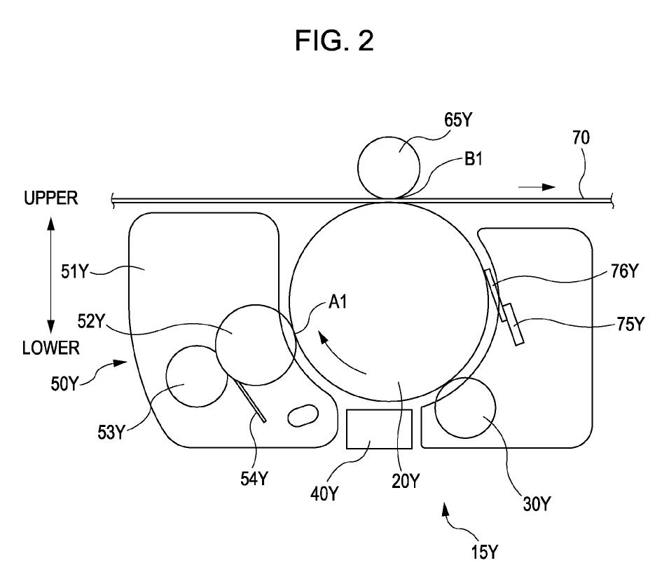

FIG. 1 is a schematic view illustrating an image forming apparatus with a developing device according to an embodiment of the invention. FIG. 2 is a schematic enlarged view showing a yellow image forming station shown in FIG. 1.

As shown in FIG. 1, an image forming apparatus 10 includes four image forming stations 15 (Y, M, C and K), an intermediate transfer belt 70, and a secondary transfer unit 80. The image forming apparatus 10 further includes a fixing unit 90, a display unit 95 configured on a liquid crystal panel serving as notification means for a user, and a control unit 100 for controlling the above units so as to operate the image forming apparatus.

The image forming stations 15 (Y, M, C and K) have functions of forming images by using yellow (Y), magenta (M), cyan (C) and black (K) toners, respectively. As the image forming stations 15 (Y, M, C and K) have similar structures, only the image forming station 15Y is described hereinafter.

The image forming station 15Y, as shown in FIG. 2 includes a charging unit 30Y, an exposure unit 40Y, a developing unit 50Y, a primary transfer section B1, and a photosensitive drum cleaning unit 75Y which are arranged along a rotational direction of a photosensitive drum 20Y as an example of a latent image carrying body.

The photosensitive drum 20Y has a cylindrical substrate and a photosensitive layer formed on an outer peripheral face thereof, and is rotatable about a central axis. In this embodiment, the drum is rotated in a clockwise direction as shown by an arrow.

The charging unit 30Y is adapted to charge the photosensitive drum 20Y. By radiating laser light from the exposure unit 40Y, a latent image is formed on the charged photosensitive drum 20Y.

The exposure unit 40Y has a semiconductor laser device, a polygon mirror, and an F-θ lens. The exposure unit 40Y radiates, to the photosensitive drum 20Y, the laser light modulated in accordance with an image signal received from a host computer (not shown) such as a personal computer or a word processor.

The developing unit 50Y is adapted to develop the latent image formed on the photosensitive drum 20Y by using the Yellow (Y) toner. In the developing unit 50Y, a developing roller 52Y as a developing agent carrying body and a toner supply roller 53Y as a toner supply member are provided in a developing chamber 51Y to which the toner is supplied from a replaceable toner cartridge described later. A regulating blade 54Y as a regulating member is brought into contact with the developing roller 52Y to make the toner on the developing roller 52Y into a thin layer.

The primary transfer section B1 is located at a position where a yellow toner image formed on the photosensitive drum 20Y is transferred to the intermediate transfer belt 70. The toners in four colors are sequentially transferred to be superposed in the respective primary transfer sections B1, B2, B3 and B4 to form a full color toner image on the intermediate transfer belt 70.

The intermediate transfer belt 70 is an endless belt suspended between a belt driving roller 71a and a driven roller 71b, and is driven and rotated by being in contact with the photosensitive drums 20 (Y, M, C and K).

The secondary transfer unit 80 is a device for transferring a monochrome toner image or a full color toner image formed on the intermediate transfer belt 70 to a transfer medium such as a paper sheet, a film or a cloth.

The fixing unit 90 is a device configured of a fixing roller 90a and pressurizing roller 90b, and is adapted to melt and fix a monochrome toner image or a full color toner image formed on the transfer medium to form a permanent image.

The photosensitive drum cleaning unit 75Y is a device that has a rubber photosensitive drum cleaning blade 76Y contacting a surface of the photosensitive drum 20Y and is adapted to remove the toner remaining on the photosensitive drum 20Y by causing the photosensitive drum cleaning blade 76Y to scrape off the toner after the toner is transferred to the intermediate transfer belt 70 in the primary transfer section B1.

Next, an operation of the image forming apparatus 10 formed of the above structure is described below.

First, when an image signal and a control signal from a host computer (not shown) are input to a main controller of the image forming apparatus via an interface, the photosensitive drum 20Y, the developing roller 52Y provided on the developing unit 50Y, the toner supply roller 53Y and the intermediate transfer belt 70 are rotated by controlling a unit controller in accordance with a command from the main controller. The photosensitive drum 20Y is sequentially charged by the charging unit 30Y at a charging position while being rotated.

A charged region of the photosensitive drum 20Y is moved to an exposing position while the photosensitive drum 20Y is being rotated. A latent image is formed on the region by the exposure unit 40Y in accordance with image information of yellow Y.

The latent image formed on the photosensitive drum 20Y is moved to a developing position by rotation of the photosensitive drum 20Y and is developed by the developing unit 50Y. With the above process, a toner image is formed on the photosensitive drum 20Y.

The toner image formed on the photosensitive drum 20Y is moved to a position of the primary transfer section B1 by rotation of the photosensitive drum 20Y and is transferred to the intermediate transfer belt 70 by the primary transfer unit. At that time, a primary transferring voltage whose polarity is inverse to a charge polarity of the toner, is applied to the primary transfer unit. As a result, the toner images in four colors formed on the respective photosensitive drums 20 (Y, M, C and K) are transferred and superposed to the intermediate transfer belt 70, and then the full color toner image is formed on the intermediate transfer belt 70.

The intermediate transfer belt 70 is driven such that a driving force from belt drive means such as a motor is transmitted to the intermediate transfer belt 70 via the belt driving roller 71a.

The full color toner image formed on the intermediate transfer belt 70 is transferred to a transfer medium such as a paper sheet by the secondary transfer unit 80. The transfer medium is transported to the secondary transfer unit 80 from a paper supply tray through a paper supply roller 94a and a registration roller 94b.

A full color liquid developing agent image transferred to the transfer medium is heated and pressurized by the fixing unit 90 so as to be melted and fixed to the transfer medium. The transfer medium is discharged by a paper discharge roller 94c after passing through the fixing unit 90.

The photosensitive drums 20 (Y, M, C and K) are destaticized by a destaticizing unit (not shown) after passing through positions of the primary transfer sections B1, B2, B3 and B4, respectively. The toners adhering to the surfaces of the respective photosensitive drums 20 are scraped off by the photosensitive drum cleaning blades 76 (Y, M, C and K) supported by the photosensitive drum cleaning units 75 (Y, M, C and K), respectively, and then the photosensitive drums 20 are made to be ready to be charged for forming next respective latent images. The scraped toners are collected in residual toner collecting sections respectively provided to the photosensitive drum cleaning units 75 (Y, M, C and K).

An intermediate transfer belt cleaning device (not shown) is provided to a portion at the driven roller 71b side of the intermediate transfer belt 70 after the secondary transferring, and is adapted to clean the intermediate transfer belt 70, after the secondary transferring. Note that, while an intermediate transferring type image forming apparatus using an intermediate transfer belt is used in the embodiment described above, a direct transferring type image forming apparatus can also be used.

Next, the developing unit 50Y, in particular, a toner conveying structure is described below.

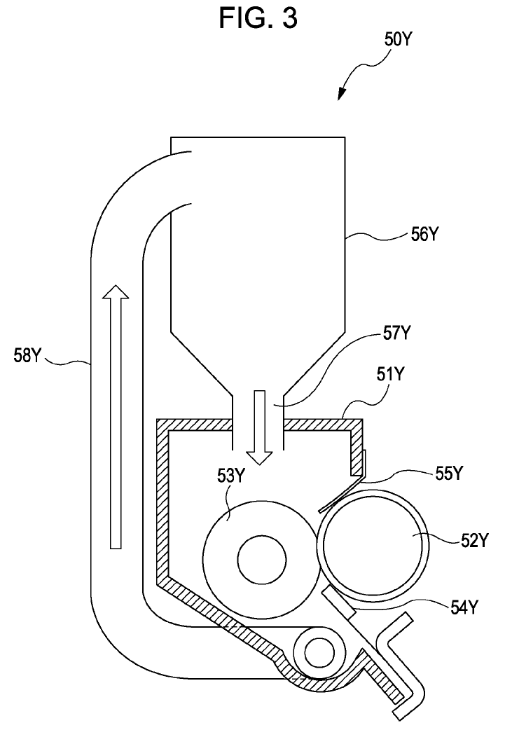

FIG. 3 is a schematic view illustrating the developing unit 50 according to the invention. As shown in FIG. 3, the developing unit 50 includes the developing chamber 51Y, the developing roller 52Y for carrying the toner stored in the developing chamber 51Y, the toner supply roller 53Y which is configured of a soft elastic porous material and is adapted to supply the toner to the developing roller 52Y, and the regulating blade 54Y which is brought into contact with the developing roller 52Y to make the toner into a thin film by regulating the amount of the toner.

The developing unit 50 further includes a seal member 55Y that seals a portion between the developing chamber 51Y and developing roller 52Y to reduce leakage of the toner toward the photosensitive drum 20Y, the replaceable toner cartridge 56Y, a first conveyance path 57Y connecting the toner cartridge 56Y to the developing chamber 51Y, and a second conveyance path 58Y connecting the developing chamber 51Y to the toner cartridge 56Y.

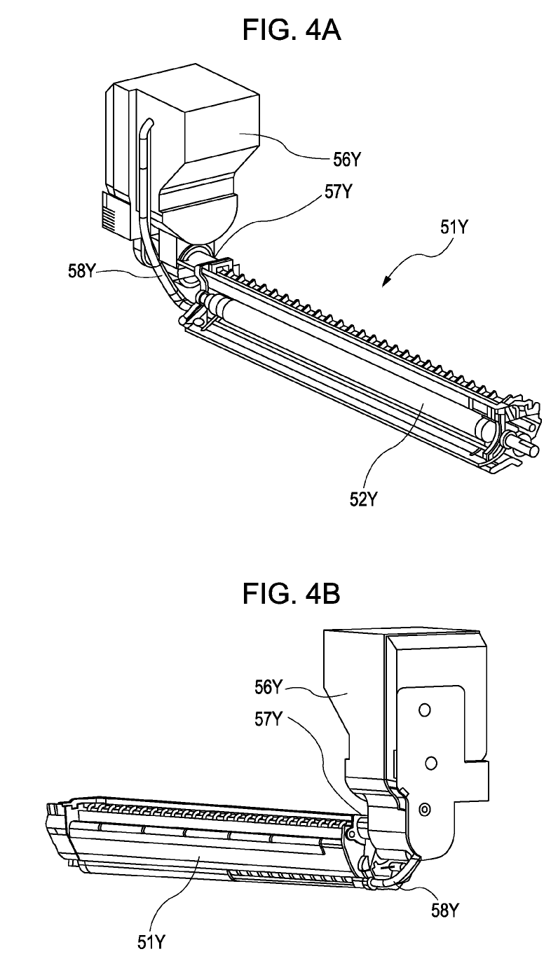

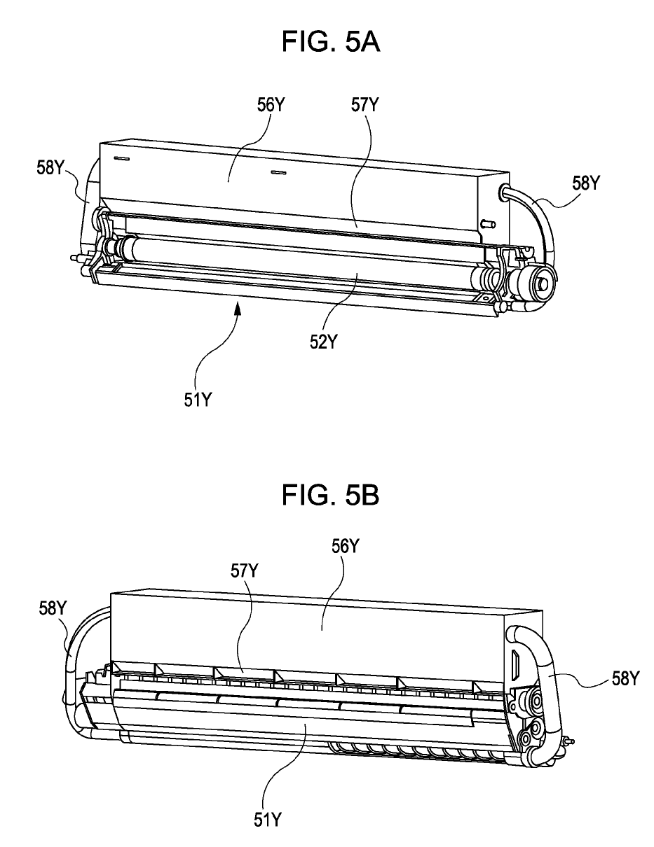

FIGS. 4A and 4B are perspective views each illustrating the developing unit 50Y of a first example and FIGS. 5A and 5B are perspective views each illustrating the developing unit 50Y of a second example. The developing unit 50Y shown in FIGS. 4A and 4B has one first conveyance path 57Y and one second conveyance path 58Y. The developing unit 50Y shown in FIG. 5A and 5B, is so configured that the first conveyance path 57Y is connected to a central part of the developing chamber 51Y and two second conveyance paths 58Y are connected to the two ends of the developing chamber 51Y, respectively.

One end of the first conveyance path 57Y is connected to an upper part of the developing chamber 51Y in the direction of gravity, and the toner is conveyed to the developing chamber 51Y from the toner cartridge 56Y. The supplying of the toner to the developing chamber 51Y from the toner cartridge 56Y through the first conveyance path 57Y, is carried out by driving of first conveying means (a part thereof is exposed and illustrated for description in FIGS. 4A, 4B, 5A and 5B) such as a screw conveyer built in the first conveyance path 57Y. The driving of the first conveying means is on-off controlled.

One end of the second conveyance path 58Y is connected to a lower part of the developing chamber 51Y in the gravity direction. The deteriorated toner remaining in the developing chamber 51Y is discharged to the toner cartridge 56Y. The discharging of the remaining toner to the toner cartridge 56Y from the lower part of the developing chamber 51Y, is carried out by driving of second conveying means (a part thereof is exposed and illustrated for description in FIGS. 4A, 4B, 5A and 5B) such as a screw conveyer built in the second conveyance path 58Y. The driving of the second conveying means is on-off controlled by a driving force different from that of the first conveying means.

In order to effectively discharge the toner remaining in the developing chamber 51Y, the developing device according to the embodiment is equipped with driving means for rotating the toner supply roller 53Y forward and backward. In the invention, when the developing roller 52Y is rotated in the counter clockwise direction in the event of printing, the toner supply roller 53Y is rotated in the clockwise direction opposite to the direction of rotation of the developing roller 52Y to supply the toner to the developing roller 52Y.

When the remaining toner is discharged in the event of replacement of the toner cartridge 56Y, the toner supply roller 53Y is rotated in the counter clockwise direction to collect the toner adhering to the toner supply roller 53Y. At that time, the developing roller 52Y can be driven to be rotated in the counter clockwise direction and the rotation of the developing roller 52Y can be stopped. However, no toner is supplied to the photosensitive drum 20Y. Note that, the toner supply roller 53Y can be rotated in any direction in the event of printing or discharging the remaining toner.

In addition, in order to accelerate the movement of the toner adhering to the toner supply roller 53Y toward the developing roller 52Y, toner supply roller bias applying means (not shown) different from the developing roller 52Y is provided to the toner supply roller 53Y.

In the event of discharging the remaining toner, a bias whose bias value is greater than that applied to the developing roller 52Y, is applied thereto from the toner supply roller bias applying means so that the movement of the toner adhering to the toner supply roller 53Y to the developing roller 52Y can be facilitated. With the above configuration, the discharging of the deteriorated toner adhering to holes of the toner supply roller 53Y particularly constituted of the soft elastic porous material can be accelerated.

Next, control of a refresh mode in the event of replacement of the toner cartridge 56Y is described below.

The determination of a replacement time of the toner cartridge 56Y is made in accordance with a signal indicating the end of toner from a toner end sensor (not shown) such as a piezoelectric element provided in the developing chamber 51Y. Alternatively, the determination of the replacement time is made when a signal for detecting a deterioration degree of the toner indicates that the deterioration degree of the toner in the developing chamber exceeds an allowable range or when the toner cartridge is empty.

Even when the signal indicating the end of toner is generated by the toner end sensor and the toner cartridge 56Y is replaced, the toner may remain at a portion around the toner supply roller 53Y or the developing roller 52Y in the developing chamber 51Y.

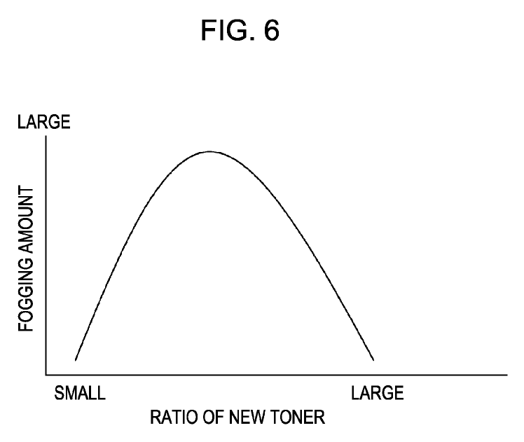

FIG. 6 is a graph showing a fogging amount with respect to a ratio of new toner to remaining toner. When the toner cartridge 56Y is replaced and new toner is supplied in the developing chamber 51Y, the new toner and the remaining toner are mixed in the developing chamber 51Y. The new toner and the remaining toner have different charge properties. When the printing is performed in a condition where they are not sufficiently agitated, fogging may occur so that image quality may be reduced. As shown in FIG. 6, the greater the degree of equivalency between the amounts of the new toner and the remaining toner, the more the fogging amount is increased.

The image forming apparatus of the embodiment has a refresh mode for refreshing the toner remaining in the developing chamber 51Y in the event of replacement of the toner cartridge 56Y in order to suppress the reduction of the image quality.

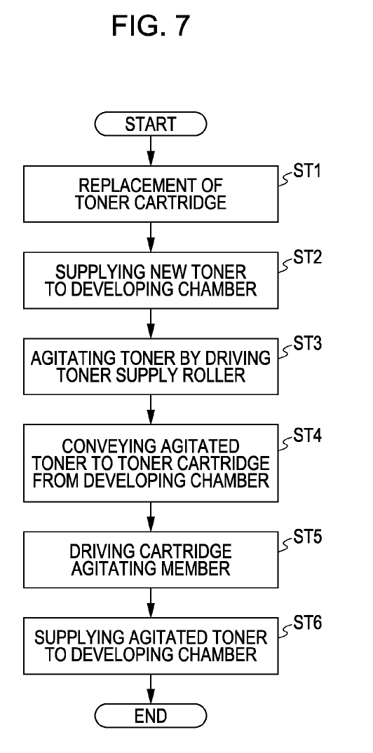

FIG. 7 is a flowchart showing a flow of the refresh mode in the embodiment. First, in step 1, the toner cartridge is replaced with a toner cartridge 56Y storing new toner (ST1). Next, in step 2, the new toner is supplied to the developing chamber 51Y from the toner cartridge 56Y through the first conveyance path 57Y (ST2).

The amount of the supplied new toner can be equal to a deficient amount with respect to a standard toner amount for the developing chamber 51Y or a full amount of the new toner in the toner cartridge 56Y.

Next, in step 3, the toner supply roller 53Y is driven in the developing chamber 51Y for a predetermined time period to agitate the new toner and the remaining toner. (ST3). At that time, the developing roller 52Y can be stopped or driven. When stopping the developing roller 52Y, a phenomenon of leaking of the toner from the seal member 55 can be suppressed. In addition to the toner supply roller 53Y, a developing chamber agitating member (not shown) may be provided, and the new toner and the remaining toner can be agitated by means of the developing chamber agitating member.

Next, in step 4, all the agitated toner including the mixed new toner and remaining toner is conveyed to the toner cartridge 56Y from the developing chamber 51Y through the second conveyance path 59Y (ST4). After that, in step 5, the agitated toner including the mixed new toner and remaining toner in the toner cartridge 56Y, and new toner in the toner cartridge 56Y not yet supplied are agitated by driving the cartridge agitating member (not shown) (ST5). Next, in step 6, the agitated toner is supplied to the developing chamber 51Y (ST6), and then the control of the refresh mode is completed. Note that, as the cartridge agitating member, each of various kinds of members having propeller, feather and auger shapes can be utilized.

The developing unit 50Y according to this embodiment includes the developing roller 52Y for carrying toner, the toner supply roller 53Y for supplying toner to the developing roller 52Y, the regulating member 54Y for regulating an amount of toner on the developing roller 52Y, the developing chamber 51Y having the developing roller 52Y, the toner supply roller 53Y and the regulating member 54Y, and the replaceable toner cartridge 56Y capable of collecting toner from the developing chamber.

When the toner cartridge 56Y is replaced with a new one 56Y storing new toner, the new toner is supplied to the developing chamber 51Y from the toner cartridge 56Y. The new toner and the toner remaining in the developing chamber 51Y are agitated in the developing chamber 51Y to form the agitated toner. After that, the agitated toner is collected in the toner cartridge 56Y so that it is possible to make the charge amount of the toner in the developing chamber 51Y to be roughly uniform when printing is first performed after the replacement of the toner cartridge.

In addition, since most of the new toner in the toner cartridge 56Y is supplied to the developing chamber 51Y, it is possible to make the charge amount of the toner more uniform.

Further, in addition, since most of the agitated toner in the developing chamber 51Y is collected in the toner cartridge 56Y, it is possible to make the charge amount of the toner more uniform.

The seal member 55Y for sealing a portion between the developing chamber 51Y and the developing roller 52Y is provided to the developing device. Since the developing roller 52Y is not rotated in the event of agitating being performed in the developing chamber 51Y, it is possible to reduce an amount of toner leaking toward the photosensitive drum 20Y.

As the toner supply roller 53Y is rotatable forward and backward, it is possible to select one of the rotational directions corresponding to a condition.

The toner cartridge 56Y has the cartridge agitating member. After the agitated toner is collected in the toner cartridge 56Y from the developing chamber 51Y, the cartridge agitating member may further agitate the agitated toner in the toner cartridge 56Y. With the above configuration, it is possible to make the charge amount of the toner more uniform.

The first conveyance path 57Y connecting the lower part of the toner cartridge 56Y to the upper part of the developing chamber 51Y, and the second conveyance path 58Y connecting the lower part of the developing chamber 51Y to the upper part of the toner cartridge 56Y may be provided to the developing device. With the above configuration, it is possible to smoothly move the toner.

In addition, the image forming apparatus according to the invention includes at least the latent image carrying body 20 on which an electrostatic latent image is formed, the developing unit 50 that forms a toner image on the latent image carrying body 20 by developing the electrostatic latent image by using a developing agent, the transfer device 80 that transfers the toner image on the latent image carrying body 20 to a transfer medium, and the fixing device 90 that fixes the toner image to the transfer medium. The image forming apparatus provided with the above described developing unit 50 can form an image with good quality due to the roughly uniform charge amount.

While the developing device and image forming apparatus according to the invention have been described above on the basis of operating principles and examples thereof, the invention is not limited to the described exemplary embodiments, and various modifications can be made within the spirit and scope of the appended claims. The entire disclosure of Japanese Patent Application No. 2008-089101, filed Mar. 31, 2008 is expressly incorporated by reference herein.

What is claimed is:

1. A developing device comprising:
a developing agent carrying body that carries toner;
a toner supply member that supplies toner to the developing agent carrying body;
a regulating member that regulates an amount of toner present on the developing agent carrying body;
a developing chamber having the developing agent carrying body, the toner supply member and the regulating member; and
a replaceable toner cartridge that supplies toner to the developing chamber and collects the toner from the developing chamber, wherein when the toner cartridge is replaced with a toner cartridge storing new toner, the new toner is supplied to the developing chamber from the toner cartridge, the new toner and the toner remaining in the developing chamber are agitated to form agitated toner, and the agitated toner is collected in the toner cartridge from the developing chamber.

2. The developing device according to claim 1, wherein all the new toner in the toner cartridge is supplied to the developing chamber.

3. The developing device according to claim 1, wherein all the agitated toner in the developing chamber is collected in the toner cartridge.

4. The developing device according to claim 1, further comprising:
a seal member that seals a portion between the developing chamber and the developing agent carrying body, wherein the developing agent carrying body is not rotated while the agitating is being carried out in the developing chamber.

5. The developing device according to claim 1, the toner supply member is rotatable forward and backward about an axis.

6. The developing device according to claim 1, further comprising:
a cartridge agitating member provided in the toner cartridge, wherein after the agitated toner is collected in the toner cartridge from the developing chamber, the cartridge agitating member further agitates the agitated toner in the toner cartridge.

7. The developing device according to claim 1, further comprising:
a first conveyance path that connects a lower part of the toner cartridge to an upper part of the developing chamber; and
a second conveyance path that connects a lower part of the developing chamber to an upper part of the toner cartridge.

8. An image forming apparatus comprising:
a latent image carrying body on which an electrostatic latent image is formed;
a developing device that forms a toner image on the latent image carrying body by developing the electrostatic latent image by using a developing agent;
a transfer device that transfers the toner image on the latent image carrying body to a transfer medium; and
a fixing device that fixes the toner image on the transfer medium, wherein the image forming apparatus includes mounted thereon the developing device according to claim 1.
